(19) United States
(12) Patent Application Publication
(10) Pub. No.: US 2002/0114339 A1
(43) Pub. Date: Aug. 22, 2002

(54) Data transmission unit for setting up a digital cross-connect connection

(76) Inventors: Marcel Kormann, Baden (CH); Erwin Koller, Horgen (CH)

Correspondence Address: Robert S. Swecker, BURNS, DOANE, SWECKER & MATHIS, L.L.P., P.O. Box 1404, Alexandria, VA, 22313-1404, US

(21) Appl. No.: 10/023,061

(22) Filed: Dec. 20, 2001

(30) Foreign Application Priority Data
Dec. 27, 2000 (DE) 100 65 929.2

(51) Int. Cl. H04L 12/28

(52) U.S. Cl. 370/404; 370/907

(57) ABSTRACT

In a method for setting up a digital synchronous cross-connect connection between data transmission units that are connected to interfaces of user devices, asynchronous interfaces are allocated an additive neutral element, and data signals that have been received in a data transmission unit via various data channels are added together. This makes it possible to accommodate even asynchronous subscribers in a synchronous cross-connect connection.

### DESCRIPTION

1. Technical Field

The invention relates to a method for setting up a digital cross-connect connection and to a data transmission unit, according to the preambles of patent claims 1 and 5, respectively.

2. Prior Art

In telecommunications, user signals, for example telephone conversations or data, are sent via data transmission units, so-called access multiplexers, to fast broadband transmission devices, which feed the user signals into a generally broadband communication network. These communication units are further used to receive user signals that have been fed into the communication network by other data transmission units, also referred to as remote stations, and to route them to user devices.

The data transmission units therefore have, at the user-device end, an interface for connection to a plurality of user devices and, at the network end, broadband transmission devices which feed data directly into the communication network or route it to superordinate transmission devices connected to the network. The data transmission devices have the task of suitably processing user signals delivered by the user devices, and of converting them into a format, a so-called relay protocol, which is understood by the other transmission units, or their respective user devices. Examples of known standardized relay protocols are ITU-T G703 and ITU-T G704. These relay protocols define, inter alia, the frame format in which time slots are organized, the number of user channels which fit into a frame and how often such a frame is updated per unit time.

Current access multiplexers are often equipped with a digital cross-connect system (DCC system), which can connect each incoming data transmission channel to each outgoing data transmission channel. The DCC system manages the respective connections of the individual data transmission units. In particular, the DCC system is responsible for correct allocation of the respective connection to the time slots of the relay protocol.

User signals can in principle be transmitted via the communication network in two ways: synchronously or asynchronously. In synchronous data transmission, signals are transmitted without pause, a neutral element being sent in the event that no information is being sent. In asynchronous data transmission, signals are transmitted only when this is necessary. The communication network is quiet in between. The connection of synchronous data transmission and asynchronous data transmission, however, proves to be relatively difficult since synchronous subscribers are constantly waiting for, and transmitting, information. This problem is resolved in the prior art by the fact that a synchronous data transmission device, which uses a protocol to establish whether or not user signals are present, is allocated to each asynchronous subscriber. If user signals are present, then they are sent, otherwise the data transmission device constantly sends the other subscribers a pause signal with the information that no user signals are being sent. This solution, however, requires a relatively elaborate and expensive application-specific configuration of the data transmission units. Further, data collision can scarcely be avoided, or can be avoided only by elaborate means.

### PRESENTATION OF THE INVENTION

It is therefore an object of the invention to provide a data transmission method and a data transmission unit which permit, even with asynchronous subscribers, a flexible cross-connect connection that detects data collision.

This object is achieved by a data transmission method and a data transmission unit having the features of patent claim 1 and patent claim 5, respectively.

According to the invention, the data transmission unit has an allocation means for allocating an additive neutral element, which denotes an inactive state of the user device and which is transmitted in the absence of user signals, to each interface of a user device or client connected to it. In the case of asynchronous interfaces, a neutral element is defined, and in the case of synchronous interfaces, the neutral element already defined by the interface is preferably used. In a preferred variant of the method, the same additive neutral element is allocated to all interfaces.

The data transmission units are provided with addition circuits, in which received data signals are added together. The transmitted neutral elements do not modify the obtained user signals during the addition, so that the user signals can be routed to the receiver. If, however, two colliding user signals are received, then this is detected by means of the addition circuit.

The inventive use of a defined additive neutral element permits different types of user devices or clients, in particular synchronous and asynchronous ones, to be connected with one and the same access multiplexer, without an elaborate configuration being necessary or data collisions remaining undetected.

Further advantageous variants of the method and advantageous embodiments are given in the dependent claims.

### BRIEF DESCRIPTION OF THE DRAWINGS

The subject matter of the invention will be explained in more detail below with reference to a preferred exemplary embodiment, which is represented in the appended drawings, in which:

FIG. 1 shows a schematic representation of a communication network with a plurality of data transmission units, and

FIG. 2 shows a schematic representation of two transmitted user signals and the received added signal.

### WAYS OF IMPLEMENTING THE INVENTION

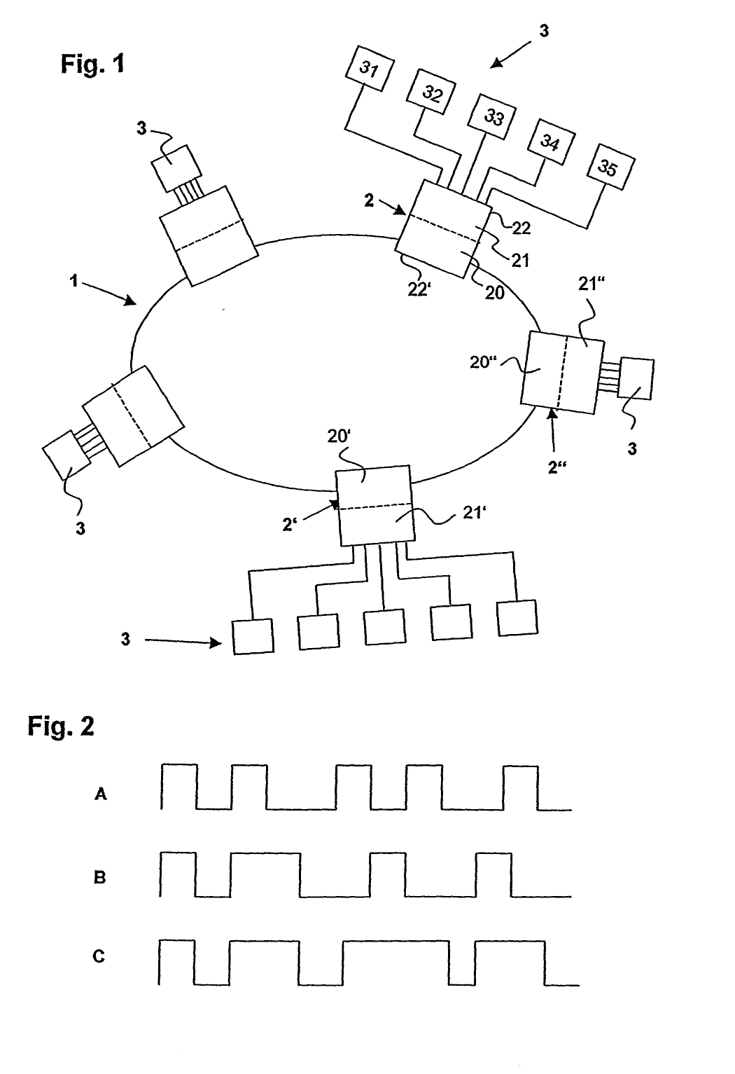

FIG. 1 schematically represents a broadband communication network 1 with a plurality of data channels. The communication network 1 is connected to a plurality of data transmission units 2, 2′, 2″, or access multiplexers, the data transmission units each consisting of a network-end part and a user-end part. The network-end part 20, 20′, 20″ contains commercially available fast broadband transmission means. In the exemplary embodiment described here, the data transmission unit is directly connected to the communication network. In another embodiment, the data transmission unit according to the invention may also be used as a connection device between superordinate access or transport multiplexers, connected to the communication network, and user devices.

The user-end part 21, 21′, 21″ has likewise known, commercially available connection means for interface connection to the user devices. At the user end, clients or user devices 3, 31, 32, 33, 34, 35 can be attached to the data transmission unit 2, 2′, 2″. Such user devices are, for example, telephone sets, computers, printers, fax machines or modems. These user devices may have different types of interfaces, synchronous as well as asynchronous. In this example, for instance, the user-end part 21 of the first data transmission unit 2 is connected to the following user devices: the user device with the reference number 31 has an RS232 interface, the device 32 has an RS422 interface, the device 33 has a 485 interface, the device 34 has an Ethernet interface and the device 35 is a telephone.

Each of these user devices 31, 32, 33, 34, 35 now delivers a different user signal via the interface to the first data transmission unit 2, the first two being asynchronous and therefore not bus-compatible, while the others are.

According to the invention, the data transmission unit 2 now has at least one allocation means 22, 23, 24, 25, 26 for allocating an additive neutral element to the respective interfaces of the user devices 31, 32, 33, 34, 35. An allocation means is preferably provided both at the user end and at the network end.

An allocation means 22, 23, 24, 25, 26 is preferably provided for each asynchronous user-end interface of the data transmission unit 2. The synchronous interfaces preferably also have such an allocation means.

The term “additive neutral element” is intended to mean a digital value which, under addition with another element, yields this other element. This additive neutral element, which is transmitted to the communication network, defines the quiescent state of the user device, i.e. the state in which no user signals are being sent. The additive neutral element hence equates to a null vector of the communication network.

In the case of a synchronous interface, the null element already available is preferably used. During the allocation of the additive neutral element for asynchronous interfaces, the allocation means resolves an electrical level of the interface from a logic level, and converts the “active” state and the “inactive” state in such a way that “inactive” corresponds to an additive neutral element. For the RS232 interface, which possesses only an active state and a passive state, the passive state is allocated to the logic state ONE as the neutral element. The RS422 interface, which discriminates between a positive voltage difference and a negative voltage difference, is given the logic state ONE for the positive voltage difference as the neutral element. An RS485 interface actually possesses three states, namely ACTIVE, INACTIVE and HIGH IMPEDANCE, and the neutral element is hence the already available HIGH IMPEDANCE signal. Ethernet likewise possesses three states, and is dealt with like RS485. In telephony, an innumerable number of states are known, which are digitized by sampling so that 256 states are available. The value for which no sound is being transmitted corresponds to the neutral element in this case. All interfaces are preferably treated uniformly, i.e. the neutral elements are arranged as identical null vectors of the same length. If the communication network also incorporates telephony, then a vector that can characterize 256 states is preferably used. With the RS232 interface, this is done e.g. by waiting in each case until 8 bits have arrived.

The communication network 1 makes available data channels between data transmission units. If data signals are now to be transmitted by one user device, for example device 31, for instance via a first data channel 10 of the communication network 1 to the second data transmission unit 2′, then these data signals will be transmitted transparently. Such a transmitted data signal is denoted by the reference A in FIG. 2. The representation shows a bit pattern, which is transmitted and received sequentially or in parallel. The remaining user devices, however, are set to the null vector, which is likewise transmitted constantly.

Collisions during the sending of data occur when, for a device which is receiving data via various channels, the data is not equal to the null vector in more than one channel. This is possible in two ways: either a second user device 3, for example a third data transmission unit 2″, is likewise transmitting data signals via a second data channel 11, or data signals of the user device 31 are being redundantly transmitted via the second data channel 11. Such a second data signal is denoted by the reference B in FIG. 2. In both cases, the second data transmission unit 2′ receives colliding data signals, which in the prior art normally entails subsequent signals from one data channel overwriting the signals from the other channel. The second data transmission unit 2′ therefore has an addition means, which adds the data signals A, B obtained from the two data channels 10, 11 and applies a modulo function to them. Modulo 256 is preferably used in this case, and limitation to a maximum value is carried out so that telephony can also be incorporated. An addition circuit, in particular, is suitable as the addition means. It operates, for example, according to an A law or μ law, i.e. two signals encoded according to an A law or μ law, respectively, are decoded and added, and the sum is re-encoded. The sum of the data signals which is obtained by the addition circuit is denoted by the reference C in FIG. 2. Since this signal no longer corresponds to a known transmission protocol, the second data transmission unit 2′ detects a collision and can take appropriate actions in order to make the relevant transmission and reception units aware of this collision. This is expedient when the data channels are transmitting digital useful data.

If the two data channels encode audio signals for telephone connections, then the addition by the addition circuit corresponds to a summation of the two audio signals. This is desirable for conference calls, so that no data collision is signaled. The limitation to a maximum value corresponds to a limitation of the sum audio signals to a maximum volume.

To explain the functionality more clearly, one transmitter end and one receiver end were assumed in the aforementioned example. It is, of course, clear that each data transmission unit 2, 2′, 2″ may either send data signals to be transmitted, or may route data signals received from the communication network to its user device. So that data transmission units with asynchronous subscribers can participate in a data collision-free cross-connect connection, they must have the inventive addition means as well as the allocation element. It is, however, possible that some of the access multiplexers connected to the communication network may have no allocation element. In that case, when they are connected only to user devices with databus-compatible interfaces, the neutral elements thereof already correspond to the null vector of the communication network.

It is advantageous that, at any time, new user devices can be attached to the access multiplexers, or existing devices can be replaced by other types. The corresponding data transmission unit merely needs to be informed of the interface type corresponding to the new or substituted user device, so that the additive neutral element can be allocated correctly.

List of references

| 1 | communication network |
|---|---|
| 2 | first data transmission unit |
| 2′ | second data transmission unit |
| 2′ ′ | third data transmission unit |
| 20 | first network-end part |
| 20′ | second network-end part |
| 20′ ′ | third network-end part |
| 21 | first user-end part |
| 21′ | second user-end part |
| 21′ ′ | third user-end part |
| 22, 23, 24, 25, 26 allocation means | |
| 3, 31, 32, 33, 34, 35 user devices | |
| A | first transmission signal |
| B | second transmission signal |
| C | third reception signal |

1. A method for setting up a digital synchronous cross-connect connection between data transmission units (2, 2′, 2″) that are connected to interfaces of user devices (3), characterized in that an additive neutral element is allocated to asynchronous interfaces, and in that the data signals that have been received in a data transmission unit (2, 2′, 2″) via various data channels are added together.

2. The method as claimed in claim 1, characterized in that the neutral elements allocated to asynchronous interfaces and neutral elements of synchronous interfaces are allocated null vectors which all have the same length.

3. The method as claimed in claim 1, characterized in that the addition is limited to a maximum value.

4. The method as claimed in claim 1, characterized in that the neutral element is allocated to an inactive state of the user device (3).

5. The method as claimed in claim 1, characterized in that after data has been sent and until new data is sent, the data transmission unit (2, 2′, 2″) transmits the additive neutral element.

6. A data transmission unit for setting up a digital synchronous cross-connect connection between user devices (3) that can be attached to it via interfaces and a multichannel network (1), characterized in that the data transmission unit (2, 2′, 2″) has an allocation means (22, 23, 24, 25, 26), for allocating an additive neutral element to interfaces of the user devices (3), and at least one addition means for adding the data signals received via various channels of the communication network (1).

7. The data transmission unit as claimed in claim 6, characterized in that null vectors that all have the same length are allocated to all additive neutral elements.

8. The data transmission unit as claimed in claim 6, characterized in that the addition means has means for limiting the added data signals.

9. The data transmission unit as claimed in claim 6, characterized in that the addition circuit has a 256 modulo function.

10. The data transmission unit as claimed in claim 6, characterized in that the addition circuit has an A law or μ law circuit.

11. The data transmission unit as claimed in claim 6, characterized in that the addition means and allocation means are permanently active.
